(19) United States
(12) Patent Application Publication
(10) Pub. No.: US 2003/0041948 A1
(43) Pub. Date: Mar. 6, 2003

(54) Co-cured joint with Z-pins

(76) Inventors: Larry R. Bersuch, Fort Worth, TX (US); Ross A. Benson, Willow Park, TX (US); Patrick D. Sheahen, Fort Worth, TX (US); Charles M. Rodenberger, Nagoya-shi (JP)

Correspondence Address: James E. Bradley, BRACEWELL & PATTERSON, LLP, Suite 2900, 711 Louisiana Street, Houston, TX, 77002-2781, US

(21) Appl. No.: 09/946,627

(22) Filed: Aug. 31, 2001

(51) Int. Cl. B32B 7/04; B32B 7/08

(52) U.S. Cl. 156/91; 156/92

(57) ABSTRACT

A method is provided for securing a three-dimensional woven preform to a first composite laminate component, the preform having a base and at least one leg extending from the base. The preform may be used to attach a second component or may be used alone to stiffen the first component. The preform and the first component are uncured, whereas the second component is cured prior to assembly. The preform is positioned on the first component, adhesive optionally being located between the preform and the first component. Z-pins are driven through the base of the preform and into the first component, the pins extending into the base and the first component. The second component is attached to the leg of the preform. A vacuum bag and tooling are used while curing the first component and the preform and the preform to the first component. The second component may be bonded or fastened to the preform.

### BACKGROUND OF THE INVENTION

1. Field of the Invention

This invention generally relates to assembly of components using Z-pins and particularly relates to assembly of components into structural joints using Z-pins and woven preforms.

2. Description of the Prior Art

Typical methods known in the art for attaching a composite skin to a composite web include forming the web as an “I” or “C” shape, making them more complex and expensive to fabricate. The flanged sections are fastened to adjacent sections using methods similar to those used with metal components, for example, by using fasteners. However, use of the fasteners adds weight to the joints.

These joints also have difficulty with standing out-of-plane loading. Typical remedies for this are thick laminate stack-ups using many layers of composite fabric and having large flange radii. While this reduces the tension forces between the layers of the flanged section, the result is a heavy joint, reducing the weight savings realized when using composites.

Z-pins have been used to join two composite, laminate components in the prior art. For example, U.S. Pat. No. 5,868,886 to Alston, et al., discloses a method of installing composite patches on a composite surface. A precured patch is placed in a prepared opening, and an ultrasonic head induces localized melting in the patch and surface. The head then drives Z-pins into the layers oft he patch and into the layers of the surface, the Z-pins extending into both components to provide for greater strength in the joint. Likewise, U.S. Pat. No. 5,589,015 to Fusco discloses joining two laminate composites by using an ultrasonic head to drive Z-pins through a first component and into a second component. In the '015 reference, the pins are held in a compressible carrier before being driven into the components, which may be cured or uncured.

### SUMMARY OF THE INVENTION

A method is provided for securing a three-dimensional woven preform to a first composite laminate component, the preform having a base and at least one leg extending from the base. The preform may be used to attach a second component or may be used alone to stiffen the first component. The preform and the first component are uncured, whereas the second component is cured prior to assembly. The preform is positioned on the first component, adhesive optionally being located between the preform and the first component. Over-wrap plies are optionally placed on the outer surfaces of preform, and Z-pins are driven through the over-wrap plies, through the base of the preform and into the first component, the pins extending into the base and the first component. The second component is attached to the leg of the preform. A vacuum bag and tooling are used while curing the first component and the preform and the preform to the first component. The second component may be bonded or fastened to the leg of the preform.

### DESCRIPTION OF THE DRAWINGS

The novel features believed to be characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings.

FIG. 1 is an exploded front view of an assembly using a Pi-shaped preform and cure tooling, the assembly being in accordance with the present invention.

FIG. 2 is a front view of the assemble of FIG. 1 after installation and in accordance with the present invention.

FIG. 3 is an exploded front view of an alternate embodiment of an assembly using a Pi-shaped preform, a sizing tool, and cure tooling, the assembly being in accordance with the present invention.

FIG. 4 is a front view of the assembly of FIG. 3 before insertion of the second component and in accordance with the present invention.

FIG. 5 is a front view of an assembly using a T-shaped preform to connect first and second components and in accordance with the present invention.

FIG. 6 is a front view of a second embodiment of an assembly using a T-shaped preform to connect first and second components and in accordance with the present invention.

FIG. 7 is a perspective view of a panel using T-shaped preforms to stiffen the panel and in accordance with the present invention.

### DESCRIPTION OF THE INVENTION

FIGS. 1 through 4 show a method for bonding two composite components using a woven preform and Z-pins and then co-curing the assembly. A three-dimensional (3-D), Pi-shaped, woven preform 11 is used to connect two composite parts 13, 15, which may be, for example, a frame member 13 and a skin 15, or other member. Parts 13, 15 may be any members of a substructure, including spars, ribs, longerons, etc. Preform 11, frame 13, and skin 15 are infused with a resin, for example, 977-3, available from Cytec Industries, Inc. of West Paterson, N.J. Preform 11 and skin 15 are not cured prior to assembly, whereas frame 13 is cured prior to assembly. Preform 11 may be woven from materials such as carbon fibers, Kevlar fibers, glass fibers, or other materials, or may be a combination of material types.

As shown in the figures, preform 11 is Pi-shaped, having a base 17 on its lower portion that has a continuous, flat lower surface 19 and a pair of spaced-apart, planar legs 21 extending vertically upward from base 17. Each leg 21 is at a position that is offset from, but near to, the center of base 17. Legs 21 are shown as being parallel to each other and generally perpendicular to base 17. In the installed position, inner surfaces 23 of legs 21 face each other for receiving frame member 13, forming a clevis. A small, upward-facing surface 25 of base 17 lies between the lower ends of legs 21. It is preferable for the outer surface of legs 21 and the upper surface of base 17 to be tapered at their outer edges, as shown, but the ends may be squared. Also, though not shown in the figures, legs 21 can be at other angles relative to each other and to base 17, which provides for parts 13, 15 to be oriented at angles other than 90°.

FIG. 1 is an exploded view of the components used to form the assembly. An adhesive film 27, for example, AF191, available from 3 M of St. Paul, Minn., is placed between lower surface 19 of preform 11 and upper surface 29 of skin 15 for adhering preform 11 to skin 15. Frame 13 and skin 15 each comprise a plurality of layers of composite material in this embodiment. Frame 13 has a cured resin matrix, but skin 15 remains uncured. Components 13, 15 are shown as flat planes, but skin 15 may be curved.

Various resin systems are sold under the terms “laminating resins” and “adhesives,” though there is no “bright-line, ” industry-standard definition by which to distinguish one from the other. The term “adhesive” is used herein to mean a resin system that has a lower modulus of elasticity and/or a higher strain-to-failure than the resin forming the matrix oft he parts to be adhered. The combination of these characteristics is described as higher toughness, and adhesives have a higher toughness than laminating resins, which tend to be more brittle and have lower crack formation loads.

Results from ASTM tests can be used to distinguish, generally, between laminating resins and adhesives. High-strength, structural laminating resins have a peel strength rating generally ranging from 0-15 pounds per linear inch, whereas the peel strength of adhesives is greater than 15 pounds per linear inch. For example, the Bell Peel test (ASTM D3167 “Standard Test Method for Floating Roller Peel Resistance of Adhesives”) shows that the peel strength of AF191 is 30-45 pounds per linear inch at room temperature, but the peel strength of 977-3, which is used to laminate the parts, is 0-6 pounds per linear inch. In addition, laminating resins generally have a tensile strength greater than 7500 pounds per square inch (psi) as tested using ASTM D638 (“Standard Test Method for Tensile Properties of Plastics”), with high-strength resins ranging to 10000 psi. Adhesives generally have tensile strengths less than 6500 psi. Thus, in the present application, “adhesives” also means resin systems with tensile strengths less than 6500 psi and a peel strength greater than 15 pounds per linear inch. “Laminating resins” is used to mean resin systems having tensile strengths greater than 7500 psi and a peel strength of less than 15 pounds per linear inch. Thus, when adhering two resin-infused components, an adhesive is used between the components to provide for a high bond strength.

If necessary for load requirements, a resin-infused textile layer forms a shear or overwrap ply 31 and is laid on the outer surface of each leg 21 that extends across the upper surface of base 17. Over-wrap plies 31 provide additional connective layers between preform 11 and skin 15. Adhesive film 27 extends beyond the outermost edge of the lower portions of over-wrap plies 31. Each over-wrap ply 31 extends upward to the upper edge of leg 21.

In order to provide for a stronger joint when preform 11 is adhered to skin 15, Z-pins 33 are driven through over-wrap plies 31, base 17 of preform 11, through adhesive film 27, and into skin 15 through surface 29. Pins 33 are also driven through surface 25 of preform 11 and into skin 15. Pins 33 push aside the fibers of preform 11, plies 31 and skin 15 as pins 33 are inserted. Pins 33 are preferably formed from graphite or titanium and are initially held within a foam carrier 35, pins 33 being vertically oriented and arranged in a matrix that provides for the desired a real density and pin locations after insertion of pins 33. Pins 33 have very small diameters, typically around 0.02 inches.

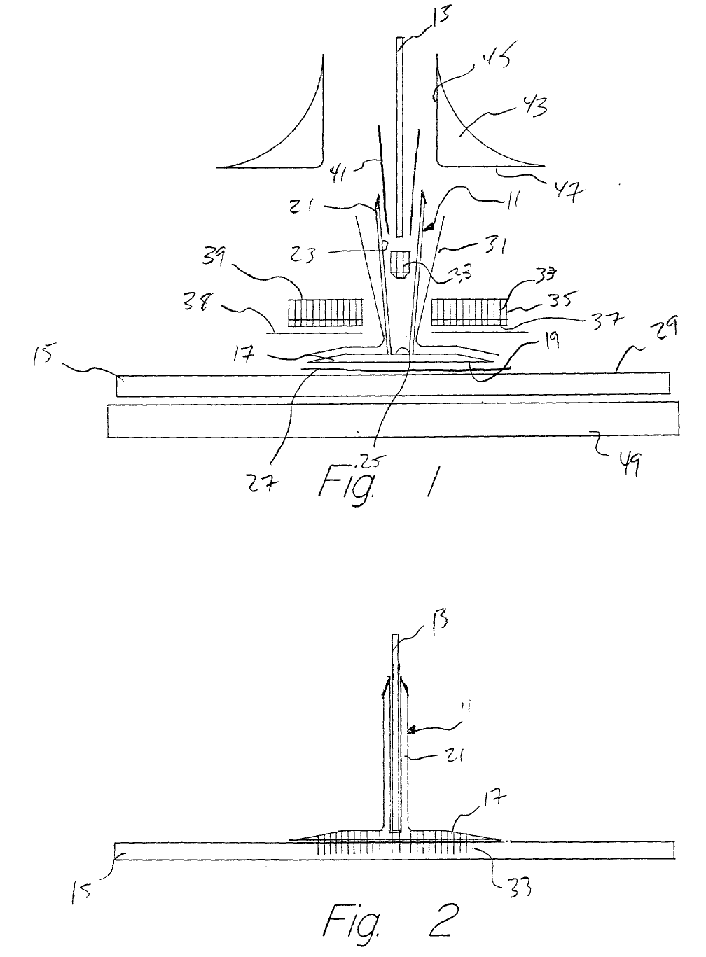

Pins 33 are inserted by using an ultra-sonic vibrating head (not shown) to drive them into skin 15. A lower surface 37 of carrier 35 containing pins 33 is placed against an optional separator film 38, which is placed on each over-wrap ply 31 over base 17. Carrier 35 is located laterally on over-wrap ply 31 to position pins 33 over the desired insertion locations. The vibrating head is placed against an upper surface 39 of carrier 35 and driven downward while vibrating. Carrier 35 is made from a foam and collapses between the head and over-wrap ply 31 as the head moves downward. Because pins 33 are rigid, the vibrating head forces pins 33 downward once the upper ends of pins 33 come in contact with the lower surface oft he head. Pins 33 pass out of carrier 35, through separator film 38, through over-wrap ply 31, through preform 11, and through adhesive film 27. Alternatively, over-wrap plies 31 may be laid on base 17 and leg 21 after pins 33 are inserted. The lower ends of pins 33 enter skin 15 at upper surface 29 and travel through a portion of the thickness of skin 15. Pins 33 are pushed into skin 15, preferably until the vibrating head is near the upper surface of over-wrap ply 31. Additional pins 33 are driven through surface 25 in the clevis of preform 11. The head is withdrawn, and carrier 35 is removed, leaving a small portion of the upper ends of pins 33 remaining above over-wrap ply 31 and surface 25. If pins 33 are made from graphite, the exposed ends of pins 33 maybe removed to leave the upper ends of pins 33 flush with over-wrap ply 31 and surface 25, as shown in FIG. 2. If pins 33 are titanium, the vibrating head is used to drive them downward until pins 33 are flush with over-wrap ply 31 or surface 25. Pins 33 made from graphite may also be driven inward until flush.

Once pins 33 are driven into the assembly, a sheet of adhesive film 41, preferably AF191, is placed against inner surface 23 of each leg 21 for adhering frame 13 within the clevis formed by legs 21. Semi-rigid over-presses 43 are used to distribute force applied to over-presses 43 across the width and height of preform 11, surfaces 45, 47 being in contact with over-wrap plies 31. The distribution of force causes more consistent bonding at the interface of skin 15 and preform 11 and a more consistent bonding within the clevis of legs 21 to frame 13. Also, rigid tool 49 is placed under skin 15 to form the desired shape of skin 15. The assembly and tooling are placed within a vacuum bag (not shown) from which the air is drawn, allowing outside air pressure to apply force to over-presses 43 and rigid tool 49. This urges base 17 toward skin 15 and forces legs 21 toward frame 13, causing preform 11 to conform to the desired shape. The assembly is preferably placed into an autoclave to cure preform 11 and skin 15 and to cure adhesive film 27, 41. Pins 33 are secured within the cured resin matrix of preform 11 and skin 15.

FIG. 2 shows a completed, cured assembly after tooling 43, 49 (FIG. 1) has been removed. Frame 13 is adhered between legs 21, legs 21 having been cured in a vertical orientation to frame 13. Base 17 is adhered to skin 15, and Z-pins 33 extend through base 17 into skin 15.

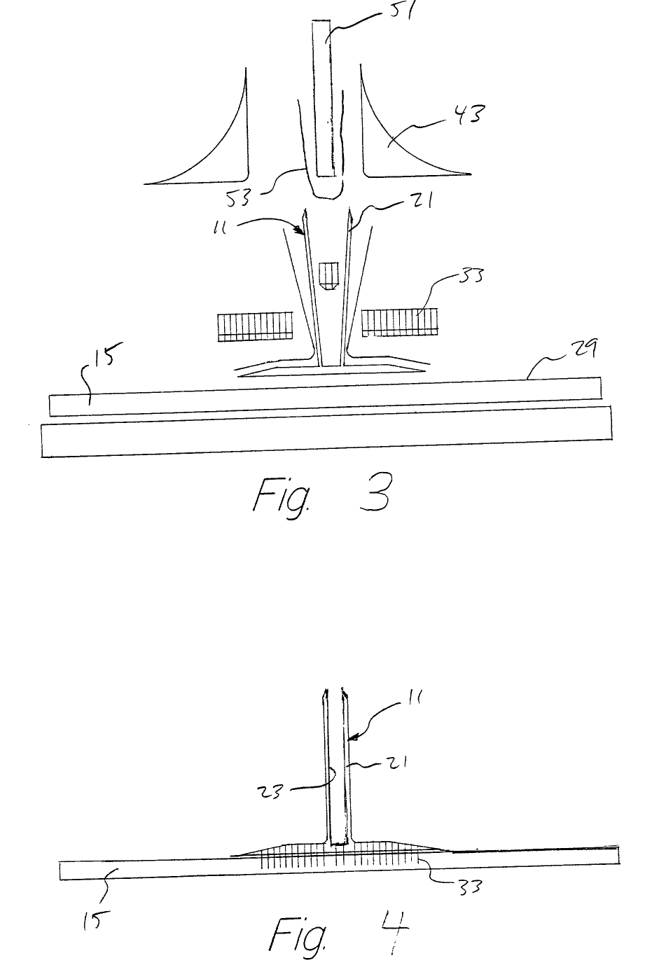

An alternative method of assembly is depicted in FIGS. 3 and 4. As described above, preform 11 is affixed to surface 29 of skin 15 and pins 33 are inserted. A sizing tool 51 and a nonstick peel ply 53 are then inserted within the clevis of preform 11, and preform 11 and skin 15 are cured with the tool in place of frame 13 (FIGS. 1 and 2). Tool 51 has a width that is larger than frame 13, and over-presses 43 ensure that legs 21 conform to the shape and size of tool 51 during curing. Peel ply 53 allows for minimum force to be used when removing tool 51 after preform 11 has been cured. As shown FIG. 4, tool 51 is removed, leaving an oversized slot between inner surfaces 23 of legs 21. Though not shown in the figures, a paste or film adhesive is introduced into the clevis, and frame 13 is then inserted into the clevis and adhered to preform 11 by the adhesive.

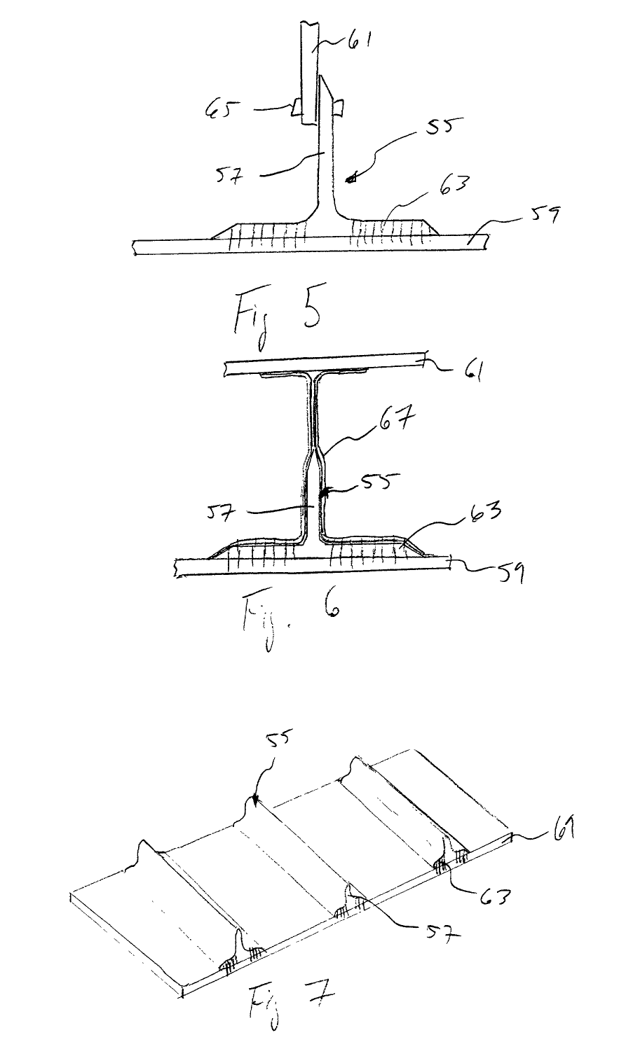

Woven preforms may also have other 3-D shapes, for example, a T-shaped preform 55 having only one leg 57. As shown in FIGS. 5 and 6, preform 55 maybe used in connecting parts 59, 61 in a substructure. FIG. 5 shows a T-shaped preform being used as a connector, base 63 of preform 55 being placed against a first, uncured, composite component 59 and Z-pinned as described above. Leg 57 of preform 55 is cured at an angle relative to base 63, though leg 57 will typically be perpendicular to base 63. After curing, a second component 61 is affixed to leg 57 using, for example, adhesives or fasteners 65.

An alternative use of T-shaped preform 55 as a connector is shown in FIG. 6. Overwrap plies 67 are laid against the outside surfaces of preform 55, over-wrap plies 67 extending beyond the height of leg 57. Component 59, preform 55, and over-wrap plies 67 are cured together. Using various tooling (not shown), the upper portion of over-wrap plies 67 can be cured in desired configurations, for example, as a straight web or as the top portion of an I-beam, as shown. Overwrap plies are cured to form connecting surfaces for receiving second component 61, which can be mounted to the flanged section of over-wrap plies 67 to complete the substructure.

FIG. 7 illustrates the use of T-shaped preforms 55 used as stiffeners for large surfaces. Preforms 55 can be Z-pinned to a skin 69 with optional over-wrap plies (not shown), as described above, then cured with leg 57 being generally perpendicular to base 63. The rigid leg provides for a higher moment of inertia, resisting bending of skin 69.

The present invention provides for several advantages. The Z-pins provide for a stronger joining of the preform and skin. Inserting Z-pins through the preform eliminates the problem of having to “bed down” the preform on previously installed Z-pins, a problem requiring shorter exposed portions of the Z-pins. Also, the problems of Z-pin breakage when removing peel plies and limitations on a real density of Z-pins are eliminated.

While the invention has been shown in only some of its forms, it is not thus limited but is susceptible to various changes and modifications without departing from the spirit thereof.

I claim:

1. A method for bonding a woven preform to a composite component, the method comprising:
(a) providing a woven preform having a base and a pair of spaced-apart legs that extend from the base and define a slot having inner surfaces, the preform being infused with uncured resin; then
(b) placing the base of the preform adjacent a surface of a composite component that is infused with an uncured resin; then
(c) inserting a plurality of pins through the base of the preform and into the surface of the component, the pins extending into the base and into the component after insertion; then
(d) curing the resin in the preform and the resin in the component.

2. The method of claim 1, further comprising:
inserting a second composite component into the slot and bonding the second component to the preform.

3. The method of claim 1, wherein:
the legs are generally parallel to each other.

4. The method of claim 1, wherein:
the legs are generally perpendicular to the base.

5. The method of claim 1, further comprising:
providing a second component that is infused with a cured resin;
inserting the second component into the slot prior to step (d); and
bonding the second component to the preform during step (d).

6. The method of claim 1, further comprising:
inserting a rigid sizing tool into the slot prior to step (d);
removing the tool and applying an adhesive into the slot after step (d); then
inserting a second component into the slot, the adhesive bonding the second component to the preform, the second component having a smaller width than the tool.

7. A method for assembling first and second laminate components, the first component having an uncured resin, the second component having a cured resin, the method comprising:
(a) providing a woven preform having a base and a pair of spaced-apart legs that extend from the base and define a slot having inner surfaces, the preform being infused with uncured resin; then
(b) placing the base of the preform adjacent a surface of the first component; then
(c) inserting a plurality of pins through the base of the preform and into the surface of the first component, the pins extending into the base and into the first component after insertion; then
(d) inserting the second component into the slot; then
(e) curing the resin in the preform and the resin in the first component, the surface of the first component being adhered to the base, at least one surface of the second component being adhered to at least one of the inner surfaces oft he slot for retaining the second component within the slot.

8. The method of claim 7, wherein:
the legs are generally parallel to each other.

9. The method of claim 7, wherein:
the legs are generally perpendicular to the base.

10. The method of claim 7, wherein:
step (e) further comprises placing over-presses that are at least semi-rigid against outer surfaces oft he preform for distributing a force across the preform while curing the preform; and
step (e) further comprises placing a rigid tool against the first component opposite the over-presses.

11. The method of claim 7, wherein:
step (b) further comprises placing an adhesive between the base of the preform and the surface of the first component.

12. The method of claim 7, wherein:
step (d) further comprises placing an adhesive between at least one of the inner surfaces of the slot and the second component.

13. The method of claim 7, further comprising:
adhering at least one over-wrap ply to the preform before performing step (c).

14. The method of claim 7, further comprising:
adhering at least one over-wrap ply to the preform after performing step (c).

15. The method of claim 7, wherein:
step (e) further comprises vacuum bagging the components and preform to ensure proper shaping and bonding.

16. A method for assembling first and second laminate components, the first component having an uncured resin, the second component having a cured resin, the method comprising:
(a) providing a woven preform having a base and at least one leg that extends from the base, the preform being infused with uncured resin; then
(b) placing the base of the preform adjacent a surface of the first component; then
(c) inserting a plurality of pins through the base of the preform and into the surface of the first component, the pins extending into the base and into the first component after insertion; then
(d) curing the resin in the preform and the resin in the first component, the surface of the first component being adhered to the base, each leg of the preform being cured at an angle relative to the base; then
(e) affixing the second component to the leg.

17. The method of claim 16, wherein:
the angle of each leg relative to the base is approximately 90 degrees.

18. The method of claim 16, further comprising:
adhering over-wrap plies to the preform before performing step (c).

19. The method of claim 16, further comprising:
adhering over-wrap plies to the preform after performing step (c).

20. The method of claim 18, wherein:
the over-wrap plies extend beyond the height of each leg; and
the over-wrap plies are cured to form a connecting surface.

21. The method of claim 19, wherein:
the over-wrap plies extend beyond the height of each leg; and
the over-wrap plies are cured to form a connecting surface.

22. A method for assembling first and second laminate components, the first component having an uncured resin, the second component having an uncured resin, the method comprising:
(a) providing a woven preform having abase and a pair of spaced-apart parallel legs that extend from the base and define a slot having inner surfaces, the preform being infused with uncured resin; then
(b) placing an adhesive on a surface of the first component and placing the preform on the adhesive; then
(c) inserting a plurality of pins through the base of the preform and into the surface of the first component, the pins extending into the base and into the first component after insertion; then
(d) inserting the second component into the slot; then
(e) placing over-presses that are at least semi-rigid against outer surfaces oft he preform, the over-presses being used for distributing a force across the outer surfaces of the preform;
(f) curing the resin in the preform and the resin in the first component, the surface of the first component being adhered to the base, at least one surface of the second component being adhered to at least one of the inner surfaces of the slot for retaining the second component within the slot.

23. The method of claim 22, further comprising:
adhering at least one over-wrap ply to the preform before performing step (c).

24. The method of claim 22, further comprising:
adhering at least one over-wrap ply to the preform after performing step (c).

25. The method of claim 22, wherein:
step (f) further comprises vacuum bagging the components and preform to ensure proper shaping and bonding.

26. The method of claim 22, wherein:
step (d) further comprises placing an adhesive between at least one of the inner surfaces of the slot and the second component.

27. A method of stiffening a laminate skin, the skin having an uncured resin, the method comprising:
(a) providing a woven preform having a base and at least one leg that extends from the base, the preform being infused with uncured resin; then
(b) placing the preform on the skin; then
(c) inserting a plurality of pins through the base of the preform and into the skin, the pins extending into the base and into the skin after insertion; then
(d) placing over-presses that are at least semi-rigid against outer surfaces oft he preform, the over-presses being used for distributing a force across the outer surfaces of the preform; then
(e) curing the resin in the preform and the resin in the skin, the skin being adhered to the base, the leg being at an angle to the base after curing.

28. The method of claim 27, wherein:
the leg is generally perpendicular to the base after curing.
